(19) United States
(12) Patent Application Publication
(10) Pub. No.: US 2008/0147933 A1
(43) Pub. Date: Jun. 19, 2008

(54) Dual-Channel Network Storage Management Device And Method

(76) Inventor: Kwok-Yan Leung, Willowdale (CA)

Correspondence Address: LIN & ASSOCIATES INTELLECTUAL PROPERTY, INC., P.O. BOX 2339, SARATOGA, CA, 95070-0339, US

(21) Appl. No.: 11/612,484

(22) Filed: Dec. 19, 2006

(51) Int. Cl. G06F 13/12; G06F 13/38

(52) U.S. Cl. 710/74

(57) ABSTRACT

A dual-channel network storage management device and method is presented, in which a connected host node and two hard disk/compact disk connection ports, on their connected host node, can access multiple hard disk devices through a network channel. In the network storage management device, a buffer memory unit is used to cache the host node access requests from the first hard disk interface of the device node and the second hard disk interface of the device node (which are electrically connected with the host node). Then a controller reads these requests from the buffer memory unit in turns, and sends them to the corresponding hard disk devices. Therefore, a dual-channel between the host node and the network storage management device is realized, as the host node is to be provided with two available hard disks for usage.

### BACKGROUND OF THE INVENTION

1. Field of the Invention

The present invention relates to a network storage management device and method, and in particular to a dual-channel network storage management device and method.

2. The Prior Arts

As the internet transmission becoming faster and cheaper, digital video and audio transmissions over the internet are usedly far more widely than before, along with the fact that the size of digital media files are quite large themselves, the upsizing developmental trend of digital media storage is therefore being driven.

Along with the trend of digital media upsizing, a single hard disk, or even a single hard disk cabinet can no longer satisfy such requirements for this type of massive data storage. Thus, two special communication protocols, namely AoE (ATA over Ethernet) and iSCSI, have been proposed thereby.

The ATA over Ethernet (AoE) is a network communication protocol proposed by Brantley Coile, in which the ATA standard hard disk device can be accessed over the Ethernet, thus a storage area network environment can be realized using standard technology at a fair price.

AoE is independent of protocols above the network layer, including of IP, UDP, TCP, etc. Since AoE can not be routed through or diverted around the area network, AoE can only be used in a storage area network in fact.

It is to be noticeable that both AoE and iSCSI are being emphasized of being cheaper storage area network solutions than Fibre Channel, but AoE is simpler and cheaper than iSCSI. Furthermore, in comparing using just the standard technical specification documents alone, the AoE protocol has only eight pages; whereas, the iSCST standard has 257 pages.

With regards to the hardware support aspects, Coraid Company has produced a hard disk cabinet which supports AoE presently, called EtherDrive®. With regards to the software aspect, Linux server with vblade, as offered by SourceForge.net®, is able to search the AoE enabled hard disk cabinet over a network. After finding the above hard disk cabinet, it can then propose storage service requests, and then use the storage space and data on the hard disk cabinet. The vblade software has two implementation formats and operating modes, where one is operated using userspace program (belonging to a part of the aoetools package), and the other is operated with the Linux kernel module.

Although AoE is a simple network protocol, the complexity of its storage operation has increased, thereby the details of AoE are described further as follows.

In AoE protocol, a block storage transfer is primarily adopted. Under this condition, ATA is being taken as a cable protocol for the hard disk. After the data is written into the hard disk, it will be transferred back as one or more blocks if it is required to be read out; and the block size is fixed; and it can be referred to as transmission block.

Then, AoE protocol directly and easily sends the ATA commands to the lower-layered network package, so that the Ethernet cable can replace the ATA interface cable (or ribbon cable) effectively to transport and transfer data blocks through all the nodes (e.g. hard disk (hard disk cabinet) or computer) over the Ethernet.

As for the ribbon cable under the ATA standard is concerned, it does not need to know what kind of data block is transferred. Additionally, neither does AoE, in which the Ethernet network, used by the AoE protocol, does not need to know what type of data blocks is being transferred. And the user can read or write any data block that they want. But in most applications, the file system is more suitable for data organization and structured manipulations.

Conventionally, a user uses the hard disk by means of file systems, such as EXT3, XFS, and NTFS, which are designed and operated in such a manner. However since the AoE uses the Ethernet network for replacing the ATA ribbon cable, it is thus likely to destroy the aforementioned method. It is dangerous for conventional file system to work under the AoE protocol, which can lead to file system corruption or making the operating system experiencing kernel panic.

The cluster file systems are used to avoid these problems in AoE, in which the devices for data block storage and transfer, the AoE hard disk or hard disk cabinet, can be simultaneously accessed by multiple computers. Thus it is able to step over the conventional ATA technology limitation of only permitting one computer to access the hard disk or hard disk group. As to the practical operational aspects, the server that can access the AoE hard disk cabinet is a cluster-based computer itself, for sharing the storage data using cluster-based mechanism. And the AoE hard disk cabinet is a shared block storage device. Examples of cluster file systems are GFS, OCFS2.

Referring to FIG. 1, a conventional storage area network environment is illustrated in an illustrative block diagram. As shown in FIG. 1, in the conventional storage area network, a giant hard disk group comprising of a plurality of hard disk cabinets 10a˜10n, in which each hard disk cabinet 10a˜10n comprising of a plurality of hard disk drawers, 11a, 11b, . . . 11f, 11g . . . , and each hard disk drawer comprising of a plurality of hard disks 12a, 12b, . . . , 12, 12g . . . . When a computer device is needed to access the above hard disks 12a, 12b, . . . , 12f, 12g, . . . , AoE or iSCSI protocol may be adopted.

Under the AoE protocol, the AoE package uses the MAC address in the Ethernet network to decide upon the AoE package's source and destination addresses. But the MAC address can only be used in a single Ethernet network, since the MAC address is broadcast only within an area network. Flow control mechanisms are provided in most current Ethernet hardware systems, thus allowing the bandwidth requirement for packet retransmission to be minimized. CRC algorithm is used for ensuring packet transmission integrity over the Ethernet network.

But under conventional storage area network environments, each computer device 17a˜17n can only use one hard disk/compact disk connection port (a typical motherboard provides two hard disk/compact disk connection ports) for accessing one of the hard disks 12a, 12b, . . . , 12f, 12g, . . . ; and the other hard disk/compact disk port can only be directly installed with a conventional hard disk device. In order to make the most of such network storage system, it is best to enable the two hard disk/compact disk connection ports on the motherboard to support such network storage system.

### SUMMARY OF THE INVENTION

The present invention is primarily intended to provide a dual-channel network storage management device and method, in which the two hard disk/compact disk connection ports, on their connected host node, can both access multiple hard disk devices through a network channel.

Based on the above purpose, the dual-channel network storage management device and method in accordance with the present invention primarily makes use of a buffer memory unit to cache the access requests from the first and second hard disk interfaces of the device node (are electrically connected with the host node, respectively). Then these access requests are obtained from the buffer memory unit by using a controller in turn, and the access requests of the host node are sent to a corresponding hard disk device via the network interface. A dual-channel formed between the host node and the network storage management devices is realized thereby, as the host node is to be provided with two hard disks for usage.

The above and other features and advantages of the present invention will be understood further to those skilled in the art by reading the following detailed description, with reference to the attached drawings.

### BRIEF DESCRIPTION OF THE DRAWINGS

The present invention will be apparent to those skilled in the art by reading the following detailed description of a plurality of embodiments thereof, with reference to the attached drawings, in which:

FIG. 1 is a block diagram illustrating a conventional storage area network environment;

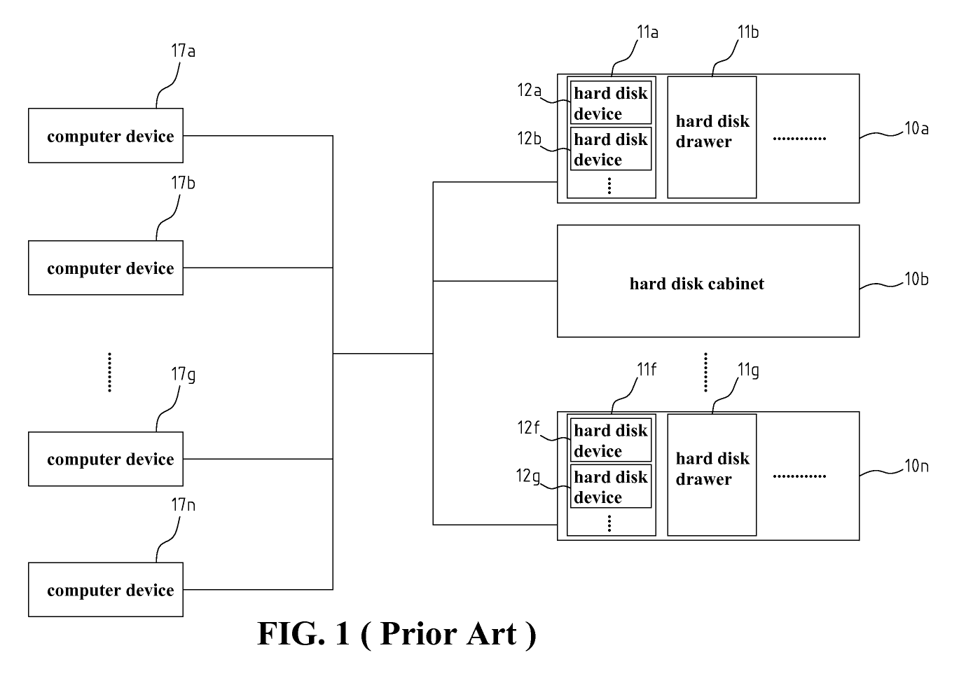

FIG. 2 is a block diagram illustrating a storage area network environment in accordance with the present invention;

FIG. 3 is a block diagram illustrating a dual-channel network storage management device in accordance with an embodiment of the present invention;

FIG. 4 is another block diagram illustrating a dual-channel network storage management device in accordance with another embodiment of the present invention; and

FIG. 5 is a block diagram illustrating a controller in accordance with the present invention.

### DETAILED DESCRIPTION OF THE PREFERRED EMBODIMENT

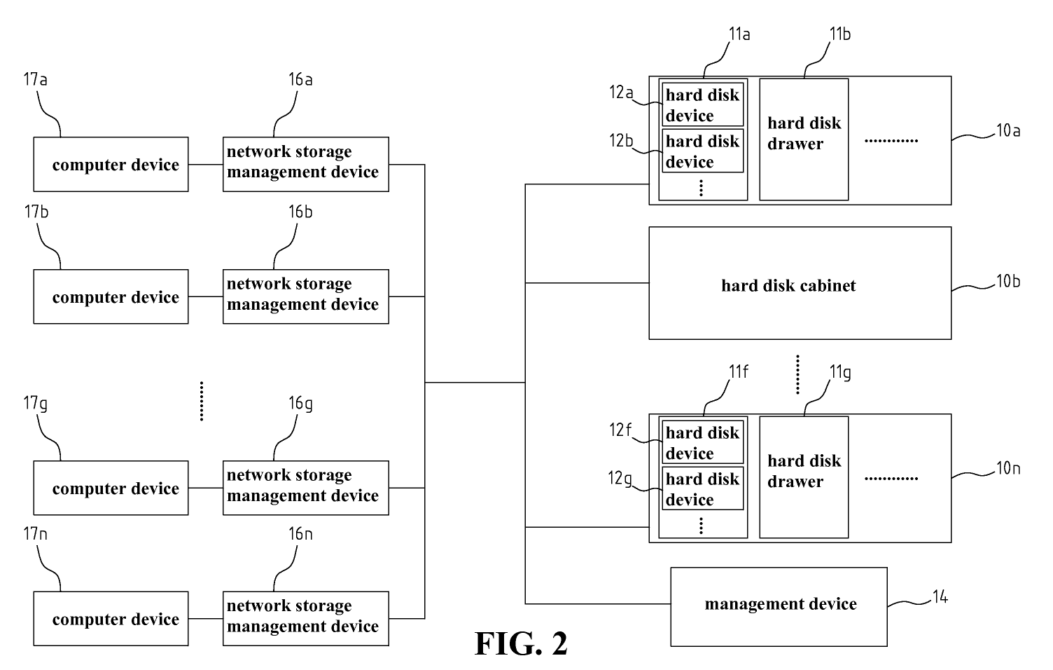

Referring to FIG. 2, a storage area network environment is illustrated in accordance with the present invention. As shown in FIG. 2, in the storage area network environment in accordance with the present invention, a giant hard disk group comprising of a plurality of hard disk cabinets 10a˜10n, and each hard disk cabinet 10a˜10n comprising of a plurality of hard disk drawers 11a, 11b, . . . , 11f, 11g, . . . , in which each hard disk drawer comprising of a plurality of hard disks 12a, . . . , 12g, . . . . When a computer device 17a, 17b, . . . , 17g, . . . , 17n is needed to access the above hard disk 12a, 12b, . . . , 12f, 12g, . . . , a corresponding dual-channel network storage management device 16a˜16n attached can be utilized.

In one embodiment, for example, when the computer device 17a (host node) is needed to use the dual-channel network storage management device 16a to access the hard disk 12f, 12g, . . . through a network channel, the network storage management device 16a will need special components to fulfill the task. Note that in particularly, the computer devices 17b, . . . , 17g˜17n and the network storage management devices 16b˜16n have the same mode of operation as that of the computer device 17a and the network storage management device 16a.

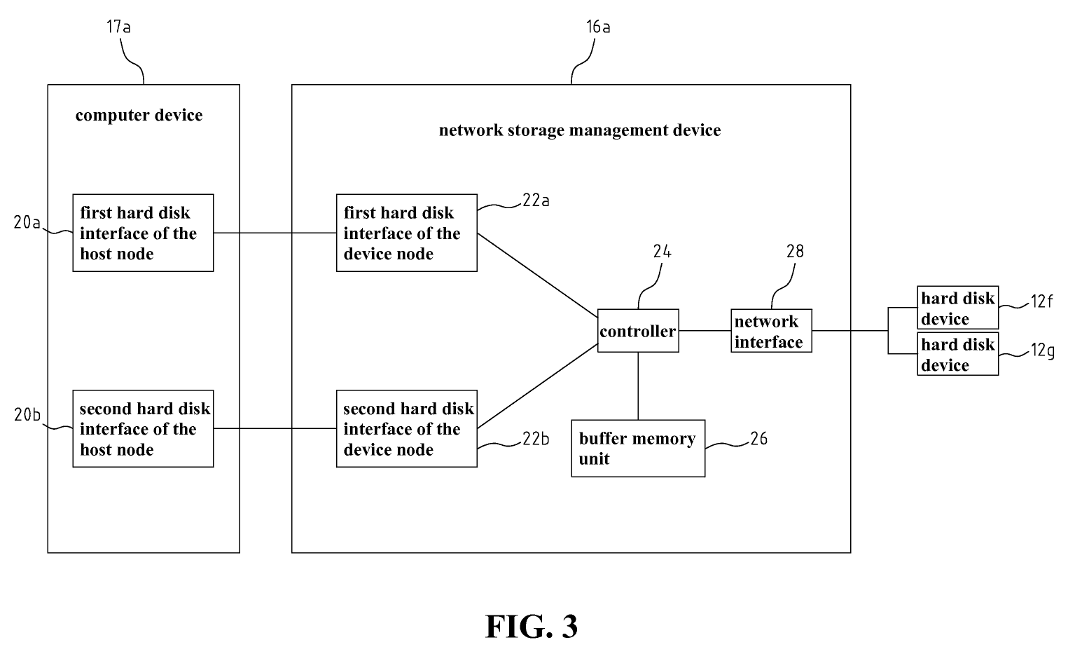

Referring to FIG. 3, a network storage management device is illustrated in accordance with an embodiment of the present invention. As illustrated in FIG. 3, a network storage management device 16a, in accordance with the embodiment of the present invention, primarily comprises a hard disk device interface group (a first hard disk interface of a device node 22a, a second hard disk interface of the device node 22b), a network interface 28, a buffer memory unit 26, and a controller 24. A computer device 17a (especially its corresponding motherboard) comprises a first hard disk interface of a host node 20a, a second hard disk interface of the host node 20b, a CPU (not illustrated), and other elements. The buffer memory unit 26 may be comprised of a single buffer memory bank (for the sharing of caching the requests from the first hard disk interface of the host node 20a and from the second hard disk interface of the host node 20b) or formed by two separated buffer memory banks (caching the requests from the first hard disk interface of the host node 20a and from the second hard disk interface of the host node 20b, respectively).

Within the network storage management device 16 in accordance with the present invention, the hard disk interface group for its corresponding devices, the first hard disk interface of the device node 22a, the second hard disk interface of the device node 22b can be electrically connected with the first hard disk interface of the host node 20a and the second hard disk interface of the host node 20b (computer device 17a), and receive the access request from the first hard disk interface of the host node 20a and from the second hard disk interface of the host node 20b. The access request is that one of the requests (e.g. the hard disk device 12f, 12g configured to the computer device 17a) of these hard disk device nodes 12a, 12b, . . . , 12f, 12g, . . . is to be provided with the needed data.

In brief, the dual-channel network storage management device 16a in accordance with the present invention, utilizes a buffer memory unit 16 to cache the access requests of the host node from the first hard disk interface of the device node 22a and from the second hard disk interface of the device node 22b (electrically connected with the host node, respectively). Then a controller 24 reads these access requests from the buffer memory unit 26 in turn, and the controller 24 sends the host node access request to the corresponding hard disk device 12f, 12g via the network interface 28, thus realizing a dual-channel between the computer device 17a and the network storage management device 16a, as if the computer device 17a is provided with two available hard disks 12f, 12g.

Under this configuration, a user will not be aware that the hard disk devices 12f and 12g being used are located at a far remote distance indeed, but rather instead is perceived to be disposed inside his own computer. Based on this network storage media configuration, in the case that the hard disk device 12f being used is out of order, the management device 14 will automatically configure another available hard disk device, such as the hard disk device 12a, even as to the point that the user would not be able to detect or sense that the hard disk device 12f, which is being used, has been damaged at all.

As an example, in one embodiment, if the user of the computer device 17a defines the hard disk devices 12f and 12g connected with the first hard disk interface of the host node 20a and with the second hard disk interface of the host node 20b, as a slot C disk device and a slot D disk device respectively, the dual-channel network storage management device 16a is used for providing the connection, and the hard disk device 12f in slot C is assigned to install the operating system, and the hard disk device 12g is assigned to back up the data in the hard disk device 12f.

When the backup data in the hard disk 12g is needed to be restored to the hard disk device 12f, the first hard disk interface of the host node 20b first issues an access request to read the hard disk device 12g (i.e. the host node access request), and this access request is sent to the network storage device 16a through the first hard disk interface of the device node 22b. Since the network storage device 16a may be dealing with other processes at the same time, to avoid confusion, the controller 24 will first cache this access request in the buffer memory unit 26, and then read the host node access requests from the buffer memory unit in turns, and send this access request to the corresponding hard disk device 12g through the network interface 28.

After the hard disk device 12g in the slot D has received the access request, it will begin to send the necessary backup data back to the network storage management device 16a through the network. Similarly, the controller 24 will first cache the data in response to the access request inside the buffer memory unit 26, and then read the data in response to the access request from the buffer memory unit 26 in turns, and send them to the hard disk device 12f in the slot C via the network interface 28. To maintain control by the computer device 17a of the entire data transmission process, it is required to go through the device node hard disk interface group (especially the first hard disk interface of the device node 22a and the first hard disk interface of the host node 20a which are corresponding to the slot C) for reporting data transmission status to the computer device 17a, as similar to using a typical hard disk device. However, the hard disk device 12f and 12g can also mutually exchange data directly in the method as described above, and does not require going through the network storage management device 16a.

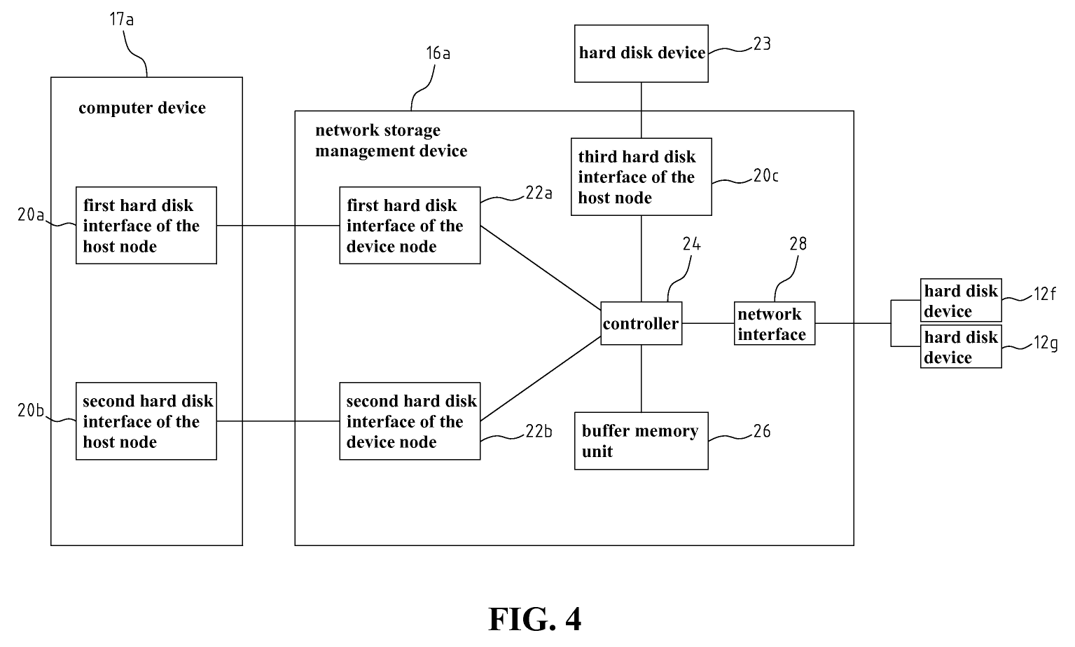

Referring to FIG. 4, a dual-channel network storage management device according to another embodiment in accordance with the present invention is illustrated. As illustrated in FIG. 4, a dual-channel network storage management device 16, apart from comprising a device node hard disk interface group (a first hard disk interface of a device node 22a, a second hard disk interface of the device node 22b), a network interface 28, a buffer memory unit 26, and a controller 24, also additionally comprises a third hard disk interface of a host node 20c, which can be electrically-connected with the hard disk device 23.

In the dual-channel network storage management device 16a, in accordance with the another embodiment of the present invention, which is configured with the third hard disk interface of the host node 20c, the controller 24 can transfer the above described transmitted data to the hard disk device 23 through the third hard disk interface of the host node 20c, or read the data from the hard disk device 23, and then transfer the data into the other hard disk devices, in accordance with the access request of the host node.

Additionally, the controller 24 can obtain the media access control addresses of the hard disk devices from the management device 14 as illustrated in FIG. 2 through a network channel. Thus the network storage management device 16a can mutually exchange data package with these hard disk devices through the network interface 28 over the network channel.

The controller 24 must be of a specialized design, so that the computer device 17a is able to support the hard disk device 12a, 12b, . . . , 12f, 12g, . . . which are used under non-conventional conditions.

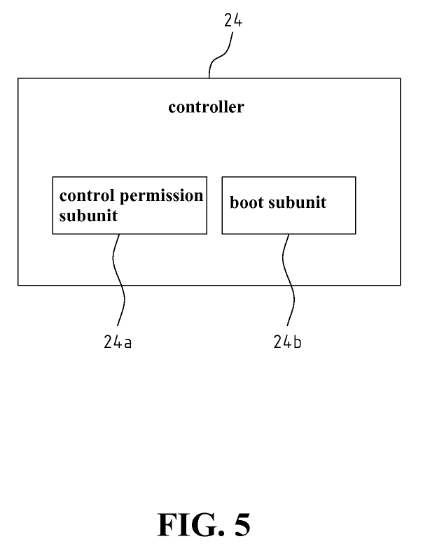

Referring to FIG. 5, a controller in accordance with the present invention is illustrated in a block diagram. As illustrated in FIG. 5, the controller 24 in accordance with the present invention further comprises a control-permission subunit 24a, and a boot subunit 24b. When the user has booted the host node, the control-permission subunit 24a will automatically provide the zero-numbered logical block (LBA0) defined under the logical block addressing (LBA) mode to the host node, rather than providing the LBA0 inside the hard disk device 12f (where the operating system is installed), then after the user chooses to boot the designated operating system stored in a designated hard disk, the boot subunit 24b obtains the corresponding LBA0 of the chosen operation system through a network channel, and then the control-permission subunit 24a transfers it back to the host CPU and to boot the chosen operating system.

The detailed description of the above embodiments is intended to illustrate the features and advantages of the present invention, so that the present invention can be understand further to the skilled in the art. Although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. A dual-channel network storage management device, wherein a host node is to access a plurality of hard disk devices through a network channel, and the host node comprising at least a first hard disk interface of the host node and a second hard disk interface of the host node, and the network storage management device, comprising:
a device node hard disk interface group, comprising a first hard disk interface of the device node and a second hard disk interface of the device node, wherein electrically connected with the first hard disk interface of the host node and the second hard disk interface of the host node, respectively, and receiving a host node access request from the first hard disk interface of the host node and the second hard disk interface of the host node, and the access request is that one request of the hard disk devices is to be provided with the needed data;
a network interface, allowing for mutually exchanging of data package between the network storage management device and the hard disk devices through the network channel;
a buffer memory unit, caching the host node access requests from the first hard disk interface of the device node and the second hard disk interface of the device node; and
a controller, caching the host node access request and the data in response to the access request inside the buffer memory unit, obtaining the access requests from the buffer memory in turns, and sending the data to the hard disk devices corresponding with the access requests via the network interface.

2. The dual-channel network storage management device as claimed in claim 1, wherein the network storage management device, further comprising:
a third hard disk interface of the host node, electrically connected with the hard disk device, wherein the controller is to access the hard disk device according to the host node access request.

3. The dual-channel network storage management device as claimed in claim 1, wherein the controller is to obtain media access control addresses of the hard disk devices from a management device through the network channel, and thus mutually exchanging the data package transferred between the network storage management device and the hard disk devices through the network interface over the network channel.

4. The dual-channel network storage management device as claimed in claim 1, wherein the controller further comprising:
a control-permission subunit, wherein a user has booted the host node, and automatically providing a zero-numbered logical block (LBA0) defined under the logical block addressing mode to the host node, and rather than providing LBA0 in the hard disk device; and
a boot subunit, after the user chooses to boot the designated operation system stored in a designated hard disk device, transferring the corresponding zero-numbered logical block (LBA0) of the chosen operation system back to the host CPU, and booting the chosen operation system.

5. A dual-channel network storage management method, wherein a host node is to access a plurality of hard disk devices through a network channel, and the host node comprising at least a first hard disk interface of the host node and a second hard disk interface of the host node, and the network storage management method, comprising:
providing a device node hard disk interface group, wherein the device node hard disk interface group comprising a first hard disk interface of a device node and a second hard disk interface of the device node, and are electrically-connected with the first hard disk interface of the host node and the second hard disk interface of the host node, respectively, and receiving a host node access request from the first hard disk interface of the host node or the second hard disk interface of the host node, and the access request is that one of the requests of the hard disk devices is to be provided with the needed data;
providing a network interface, wherein the network interface is used to mutually exchange data package between the network storage management device and the hard disk devices through the network channel;
providing a buffer memory unit, wherein the buffer memory unit is used for caching the host node access request from the first hard disk interface of the device node and the second hard disk interface of the device node;
caching the host node access request and the data in response to the access request inside the buffer memory unit; and
obtaining the access request from the buffer memory unit in turns, and sending it to the hard disk device corresponding with the access request through the network interface.

6. The dual-channel network storage management method as claimed in claim 5, wherein the network storage management method, further comprising:
providing a third hard disk interface of the host node, wherein the third hard disk interface of the host node is used to electrically-connect with a hard disk device, and the controller is to access the hard disk device according to the host node access request.

7. The dual-channel network storage management method as claimed in claim 5, wherein the control method is to obtain a media access control address of the hard disk devices from a management device through the network channel, and thus mutually exchanging the data package transferred between the network storage management device and the hard disk devices through the network interface over the network channel.

8. The dual-channel network storage management method as claimed in claim 5, wherein the control method further comprising:
providing automatically a zero-numbered logical block (LBA0) defined under the logical block addressing mode to the host node, and rather than providing LBA0 in the hard disk device when a user has booted the host node; and
transferring the corresponding zero-numbered logical block (LBA0) of the chosen operation system back to the host CPU after the user chooses to boot the certain operation system stored in the certain hard disk device, and booting the chosen operation system.
